(19) United States
(12) Patent Application Publication
(10) Pub. No.: US 2026/0017781 A1
(43) Pub. Date: Jan. 15, 2026

(54) SYSTEMS AND METHODS FOR QUASI-DOPPLER SHIFT INTERFEROMETER

(71) Applicant: GlobalWafers Co., Ltd., Hsinchu (TW)

(72) Inventors: Benno Orschel, Frontenac, MO (US); Markus Jan Peter Siegert, Key West, FL (US); Uwe Hermes, Portland, OR (US)

(21) Appl. No.: 19/265,537

(22) Filed: Jul. 10, 2025

Related U.S. Application Data
(60) Provisional application No. 63/670,014, filed on Jul. 11, 2024.

(51) Int. Cl. G06T 7/00; G01B 11/24; G06T 7/20; G06T 7/521; G06T 7/55

(52) U.S. Cl. CPC G06T 7/001; G01B 11/2441; G06T 7/20; G06T 7/521; G06T 7/55; G06T 2207/30148

(57) ABSTRACT

A computer device includes at least one processor in communication with at least one memory device. The at least one processor is programmed to: a) receive a plurality of images for a continuous scan phase shift interferometry (PSI), wherein the plurality of images includes a first plurality of pixels of a front surface of a sample and a second plurality of pixels of a back surface of a sample; b) simultaneously perform a first plurality of intensity scans of each pixel in the first plurality of pixels and a second plurality of intensity scans of each pixel in the second plurality of pixels; c) identify zero transitions for each of the first plurality of pixels; d) identify zero transitions for each of the second plurality of pixels; and e) compare the plurality of zero transitions to determine a relative movement and deformation of the sample during the PSI scan.

### CROSS REFERENCE TO RELATED APPLICATIONS

This application claims the benefit of and priority to U.S. Provisional Application No. 63/670,014, filed Jul. 11, 2024, which application is hereby incorporated by reference in its entirety.

### FIELD

The field of the disclosure relates to interferometry images of semiconductor wafers and, more particularly, to systems and methods for double Fizeau-interferometer measuring thickness, shape, flatness, and nano-topography metrics of a moving and deforming wafer.

### BACKGROUND

Conventional Phase Shift Interferometers used in wafer metrology assume a static sample (wafer). They record a series of fringe images at a series of wavelengths and assume that the wafer remains static during the time it takes to record the fringe images. However, the wafer is subject to temperature changes and gripper forces, which induce shape changes which develop during the recording of the series fringe images.

Shape changes and motion during measurement manifest by shortening the fringe intensity period seen by the camera on one side (i.e., front) while lengthening it on the other side (i.e., back). Because of its similarity to the wavelength dilation or contraction by doppler effect, we like to call this method quasi-doppler-PSI. This has a similar effect on the final calculated wafer surface as a mis-calibrated cavity or LASER linearization and results in measurement errors, showing up as so-called fringe-print-through artefacts. Accordingly, a system to improve the PSI analysis of flat surface is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system includes a computing device that may include at least one processor in communication with at least one memory device. The at least one processor may be configured to: a) receive a plurality of images for a continuous scan phase shift interferometry (PSI), wherein the plurality of images includes a first plurality of pixels of a front surface of a sample and a second plurality of pixels of a back surface of a sample; b) simultaneously perform a first plurality of intensity scans of each pixel in the first plurality of pixels and a second plurality of intensity scans of each pixel in the second plurality of pixels; c) identify zero transitions for each of the first plurality of pixels; d) identify zero transitions for each of the second plurality of pixels; and e) compare the plurality of zero transitions to determine a relative movement and deformation of the sample during the PSI scan. The system may have additional, less, or alternate functionalities, including those discussed elsewhere herein.

In another aspect, a computer-implemented method may be performed by a computer device including at least one processor in communication with at least one memory device. The method may include a) receiving a plurality of images for a continuous scan phase shift interferometry (PSI), wherein the plurality of images includes a first plurality of pixels of a front surface of a sample and a second plurality of pixels of a back surface of a sample; b) simultaneously performing a first plurality of intensity scans of each pixel in the first plurality of pixels and a second plurality of intensity scans of each pixel in the second plurality of pixels; c) identifying zero transitions for each of the first plurality of pixels; d) identifying zero transitions for each of the second plurality of pixels; and e) comparing the plurality of zero transitions to determine a relative movement and deformation of the sample during the PSI scan. The method may have additional, less, or alternate functionalities, including those discussed elsewhere herein.

In a further aspect, a computer device includes at least one processor in communication with at least one memory device. The at least one processor may be configured to: a) receive a plurality of images for a continuous scan phase shift interferometry (PSI), wherein the plurality of images includes a first plurality of pixels of a front surface of a sample and a second plurality of pixels of a back surface of a sample; b) simultaneously perform a first plurality of intensity scans of each pixel in the first plurality of pixels and a second plurality of intensity scans of each pixel in the second plurality of pixels; c) identify zero transitions for each of the first plurality of pixels; d) identify zero transitions for each of the second plurality of pixels; and e) compare the plurality of zero transitions to determine a relative movement and deformation of the sample during the PSI scan. The computer device may have additional, less, or alternate functionalities, including those discussed elsewhere herein.

In another aspect, at least one non-transitory computer-readable media having computer-executable instructions embodied thereon, when executed by a computing device including at least one processor in communication with at least one memory device, the computer-executable instructions may cause the at least one processor to: a) receive a plurality of images for a continuous scan phase shift interferometry (PSI), wherein the plurality of images includes a first plurality of pixels of a front surface of a sample and a second plurality of pixels of a back surface of a sample; b) simultaneously perform a first plurality of intensity scans of each pixel in the first plurality of pixels and a second plurality of intensity scans of each pixel in the second plurality of pixels; c) identify zero transitions for each of the first plurality of pixels; d) identify zero transitions for each of the second plurality of pixels; and e) compare the plurality of zero transitions to determine a relative movement and deformation of the sample during the PSI scan. The non-transitory computer-readable media may have additional, less, or alternate functionalities, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed. Each Figure depicts an embodiment of a particular aspect of the disclosed systems and methods, and that each of the Figures is intended to accord with a possible embodiment. Further, wherever possible, the following description refers to the reference numerals included in the following Figures, in which features depicted in multiple Figures are designated with consistent reference numerals.

FIG. 1 illustrates a diagram of a system for performing phase shift interferometry (“PSI”) to detect irregularities on a surface of a wafer.

FIG. 2 illustrates a diagram of another system for performing phase shift interferometry (“PSI”) to detect irregularities on surfaces on both sides of a wafer both shown in FIG. 1, simultaneously.

FIG. 3 illustrates an image taken by the image capture device without a wafer shown in FIG. 1.

FIG. 4 illustrates an image taken by the image capture device with a wafer shown in FIG. 1.

FIG. 5A illustrates an intensity graph of a point on the front of a wafer shown in FIG. 1.

FIG. 5B illustrates an intensity graph of the point shown in FIG. 5 on the back of a wafer shown in FIG. 1.

FIG. 6 illustrates examples of the Quasi-Doppler-Effect described herein, in accordance with at least one embodiment.

FIGS. 7A-7D show a set of graphs showing the shape change of the wafer, relative to the first image.

FIG. 8 illustrates a process for double Fizeau-interferometer measuring thickness, shape, flatness, and nano-topography metrics of a moving and deforming wafer.

FIG. 9 illustrates an example system for performing the process shown in FIG. 8.

FIG. 10 illustrates an example configuration of a user computer device.

FIG. 11 illustrates an example configuration of a server computer device.

Like reference symbols in the various drawings indicate like elements.

### DETAILED DESCRIPTION

The field of the disclosure relates to interferometry images of semiconductor wafers and, more particularly, to systems and methods for double Fizeau-interferometer measuring thickness, shape, flatness, and nano-topography metrics of a moving and deforming wafer. Provisions of the present disclosure relate to continuous scanning PSI and a combined statistical analysis of fringe periods in every pixel of both, the front and back, cameras. During a continuous scan PSI, the intensity scans of each partial cavity pixel are normalized to a range of +/−1. Then the zero transitions of all pixels are found, numbered and, together with their corresponding frame numbers, are statistically evaluated by 3-dimensional polynomial regression analysis. Dimensions 1 and 2 of the polynomial model describe wafer shape deformation and dimension 3 describes the change of dimensions 1 and 2 in time.

Zero transition of the front and back sides of a sample are disturbed in exactly opposite direction. A zero transition occurs when the normalized value of a pixel changes from a positive to a negative value or from a negative value to a positive value. The zero transitions are identified with their corresponding frame numbers. For the purposes of this discussion, frame numbers are an image's position in the sequence. The systems and methods described herein use the zero transitions to find relative motion and shape changes of a wafer during measurement. This is then used for further measuring the wafer. If the wafer is static, then it is expected that the front and the back have the same number of zero transitions.

In some embodiments, a cycle of continuous scanning PSI includes capturing 256 images of the wafer and the partial cavity viewed around the wafer. During each cycle, there is a chance that the wafer will change a little bit due to temperature. This change in wafer shape and position potentially causes a significant difference between the front and the back of the wafer, affecting front and back in exactly opposite direction.

The systems and methods described herein use the zero transitions from the back and front of the wafer. The zero transitions are used in a model to determine the relative shape and position change of the wafer in time. For the systems and methods described herein, the points of the wafer are determined to be moving relative to the reference planes and the interferometer. The systems and methods described herein use the relative changes and the zero transitions in the multitude of all pixels to calculate the relative wafer shape and position change during the measurement. This correction is performed before the actual phase calculations.

One reason for performing this correction is to prevent measurement errors that may occur when it is assumed that a wafer is not moving. The errors could show up as fringe-print-through artefacts, which often show up in the original tool control system.

During a continuous scan PSI, the intensity scans of each pixel of front and back surfaces of the wafer are normalized to a range of +/−1. Then the zero transitions of all those pixels are found, numbered, and together with their corresponding frame numbers, are statistically evaluated by polynomial regression analysis, modelling movement and deformation of the wafer during the PSI scan time.

Systems and methods implementing the algorithms of the present disclosure can be used for inspection of any suitable semiconductor wafer product. Such systems and methods may suitably be used to characterize wafer thickness, shape, flatness metrics, and nanotopography of the wafer. In some embodiments, the present disclosure can be implemented using a WaferSight tool (e.g., a WS1 generation interferometry tool) available from KLA-Tencor, Milpitas, CA.

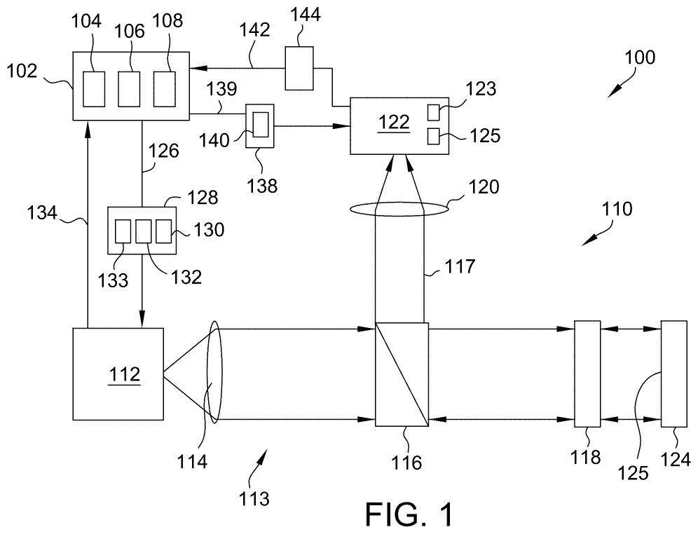

FIG. 1 illustrates a diagram of a system 100 for performing phase shift interferometry (“PSI”) to detect irregularities on a surface 125 of a wafer 124. System 100 includes an analyzer device 102 and an interferometer 110. Analyzer device 102 includes a plurality of computing devices, including a first computing device 104, a second computing device 106, and a third computing device 108. In other implementations, analyzer device 102 includes a different number of computing devices. Interferometer 110, which in at least some implementations, is a Fizeau interferometer, includes a light source 112, a first lens 114, a beam splitter 116, a reference plane 118, a second lens 120, and an image capture device 122, such as a camera. In operation, wafer 124, which is for example a silicon wafer, is placed opposite light source 112.

Reference plane 118, which is semi reflective, is disposed between light source 112 and wafer 124. Beam splitter 116 is disposed between light source 112 and reference plane 118. During operation of system 100, light source 112 emits a light beam 113, which passes through first lens 114. A first portion of light beam 113 is reflected by reference plane 118. A second portion is transmitted through semi-reflective reference plane 118 and reflected by surface 125 of wafer 124. Beam splitter 116 directs the reflected light 117 (e.g., the first portion and the second portion) towards image capture device 122. The reflected light 117 passes through second lens 120 to image capture device 122 which samples reflected light 117.

Analyzer device 102 is communicatively coupled to light source 112 and image capture device 122. More specifically, analyzer device 102 transmits light source instruction signals 126 to light source 112. Light source instruction signals 126 include light source instructions 128. Light source instructions 128 include a control function for cyclically emitting different wavelengths 130, for example as a function of time and/or a number of samples that have been obtained. In some implementations, wavelengths 130 is a range or set of wavelengths, and instructions 128 additionally include a currently selected wavelength 132, and a time period 133 during which light 113 is to be emitted at each of the wavelengths 130. Accordingly, light source 112 cycles through wavelengths 130, starting with selected wavelength 132, and emits each wavelength 130 for the time period 133. In at least some implementations, light source 112 transmits a response signal 134, for example acknowledging receipt of light source instruction signal 126.

Analyzer device 102 transmits image capture instruction signals 136 to image capture device 122. Image capture instruction signals 136 include image capture instructions 138. Image capture instructions 138 include an exposure time 140, representing an amount of time that image capture device 122 is to receive reflected light 117 to generate a sample 144. Image capture device 122 transmits image signals 142 to analyzer device 102. Image signals 142 include samples 144 generated by image capture device 122 by receiving reflected light 117 during exposure time 140. As described in more detail, image capture device 122 repeatedly captures reflected light 117 during repeated exposure times 140. Additionally, image capture device 122 performs the capture of reflected light 117 for each of a plurality of light sensors 123, for example charge coupled devices (CCDs), included in image capture device 122. Light sensors 123 are associated with respective pixels, described in more detail herein. While system 100 includes an interferometer 110, other implementations do not include interferometer 110 and instead project a moving fringe pattern (e.g., light 117) onto surface 125, as described in more detail herein.

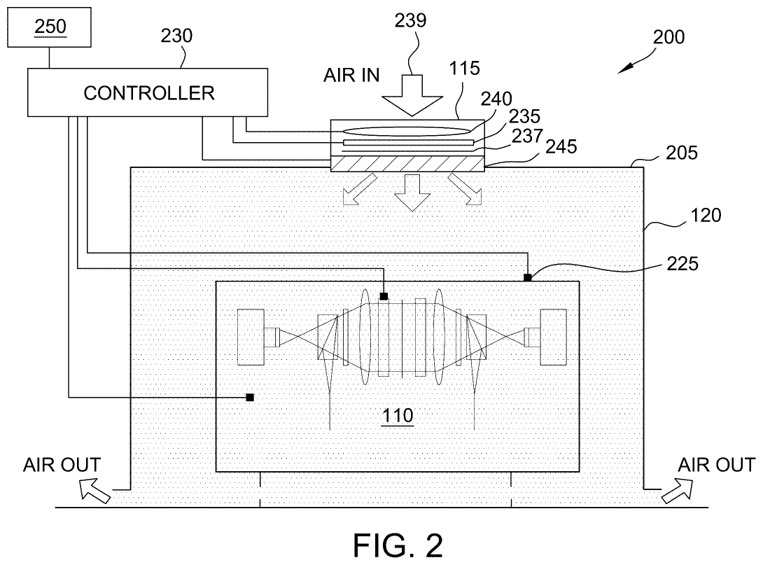

FIG. 2 illustrates a diagram of another system 200 for performing phase shift interferometry (“PSI”) to detect irregularities on surfaces 125 on both sides of a wafer 124 (both shown in FIG. 1) simultaneously. In some embodiment, system 100 is a part of system 200. Whereas the inventive concept can be employed in conjunction with many types of temperature- and vibration-sensitive equipment (as an example, medical instrumentation), the invention will be illustrated herein with an embodiment directed to interferometric measurement systems. The embodiment of FIG. 2 a takes advantage of an existing system that has skin panels 205 which enclose interferometers 110 to create an enclosed minienvironment having forced air circulation. This system 200 may be modified as follows: the air circulation unit 215 that delivers air into the cavity 220 may be modified such that the temperature and the speed of its output to the cavity 220 are controllable. The cavity 220 refers to the space between the two semi-transparent reference planes 118. Note that varying the speed of air circulation or the fan speed changes the amplitude and the frequency of the acoustic noise and mechanical vibration. Multiple temperature sensors 225 may be mounted on interferometers 110 or at any other positions where temperature control is desired. Thus the positioning of the sensors 225 can be customized according to the details of the measurement or metrology system within the cavity 220, to provide more accurate temperature feedback to control unit 230. A heating element 235 may be inserted between fan 240 and air filter 245 of unit 215. Optional cooling element 137 may be inserted at any position near air inlet 239. Computer 250 may connect to control unit 230, and may also be used for data acquisition. Control unit 230 controls heating element 235, cooling element 237, and speed of fan 240. In some embodiments, a single heating element 235 and a single cooling element 237 provides sufficient temperature control, and the multiple sensors 225 provide accurate temperature measurement at multiple points of interest.

Note that the configuration shown in FIGS. 1 and 2 are exemplary and not limiting. For example, in contrast to how it is shown in FIG. 2, the fan that blows air into the mini-cavity 220 is not required to be directly at an opening, i.e., proximal, to the mini-cavity 220. It can be placed in a position removed from the mini-cavity 220, and a duct (not shown) can be used to bring air into the mini-cavity 220. In such a case, the air circulation would still cause vibration and acoustic noise.

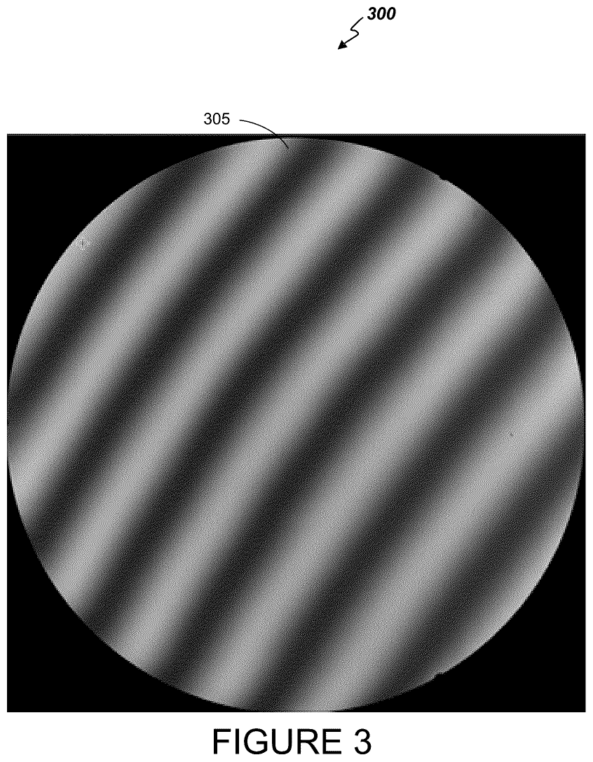

FIG. 3 illustrates an image 300 taken by the image capture device 122 without a wafer 124 (both shown in FIG. 1). More specifically, image 300 shows the background 305 of the cavity 220 (shown in FIG. 2). The background 305 of the cavity 220 has the potential to change over time due to temperature and other factors. Accordingly, the systems and methods described herein are configured to account for those changes in real-time.

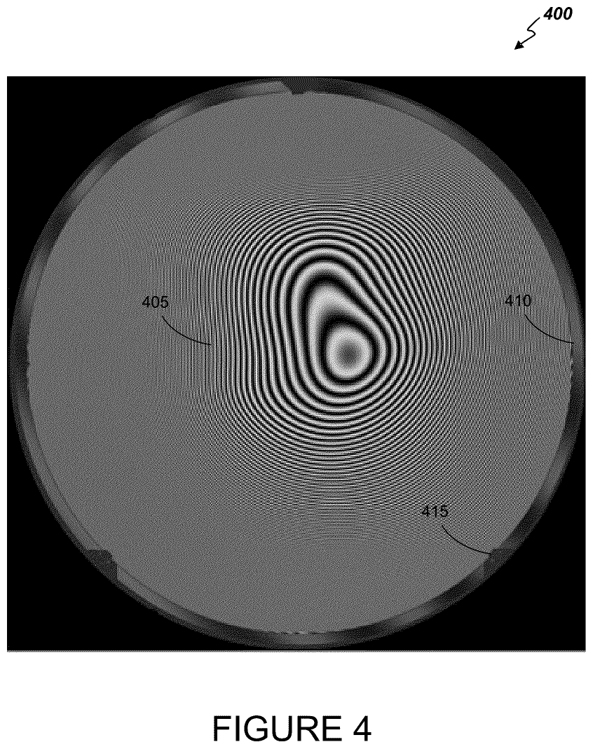

FIG. 4 illustrates an image 400 taken by the image capture device 122 with a wafer 124 (both shown in FIG. 1). More specifically, image 400 shows the wafer image 405 of the wafer 124. Image 400 also includes the background 305 (shown in FIG. 3) of the cavity 220 (shown in FIG. 2) in a ring 410 around the wafer image 405. Image 400 also includes the wafer grippers 415 that hold the wafer 124 vertically. The wafer image 405 and the background ring image 410 are used with the systems and methods described herein.

The background 305 of the cavity 220 has the potential to change over time due to temperature and other factors. Accordingly, the systems and methods described herein are configured to account for those changes in real-time.

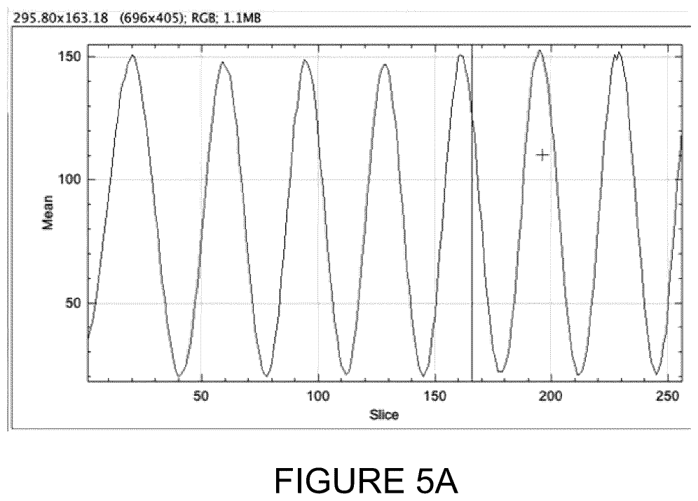

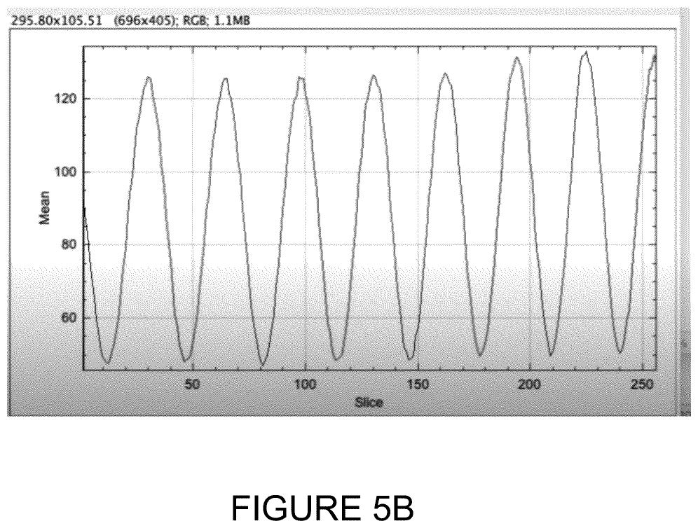

FIG. 5A illustrates an intensity graph of a point on the front of a wafer 124 (shown in FIG. 1). More specifically, the point is 696×405. The graph shows the intensity of the point from different images taken during a cycle of the continuous scan of the wafer 124. The graph shows multiple zero transitions. A zero transition occurs when the normalized value of a pixel changes from a positive to a negative value or from a negative value to a positive value. The zero transitions are identified with their corresponding frame numbers. For the purposes of this discussion, frame numbers are an image's position in the sequence. The point shown in FIG. 5A is also shown in FIG. 3.

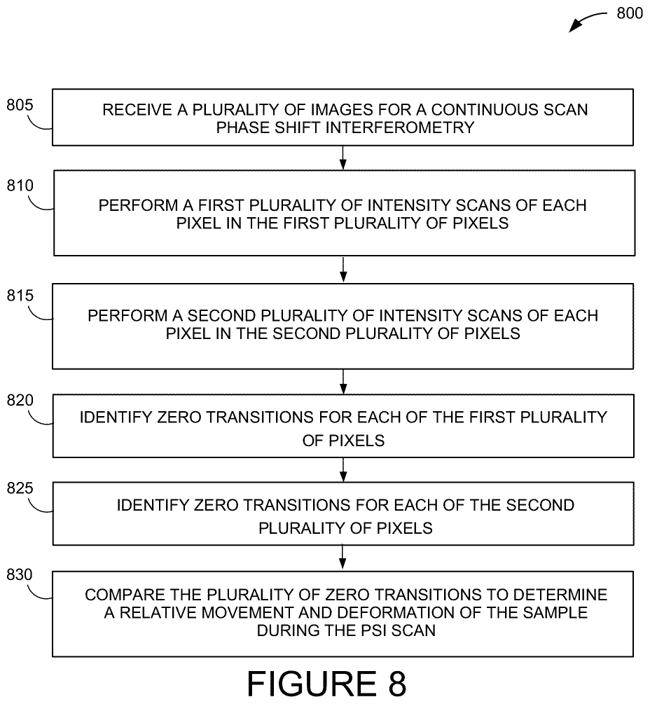

FIG. 5B illustrates an intensity graph of the point shown in FIG. 5A on the back of a wafer 124 (shown in FIG. 1). More specifically, the point is 696×405. The graph shows the intensity of the point from different images taken during a cycle of the continuous scan of the wafer 124. The graph shows multiple zero transitions, but a different number than those for the point shown in FIG. 5A. The values shown in FIG. 5B were taken at the exact same time as those in FIG. 5A. This means that the wafer 124 has changed shape. The process 800 (shown in FIG. 8) describes how to correct for this issue. The point shown in FIG. 5B is also shown in FIG. 4.

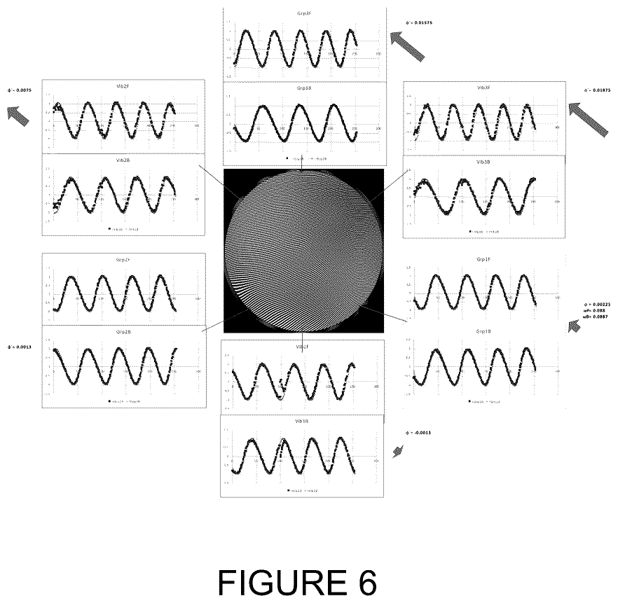

FIG. 6 illustrates examples of the Quasi-Doppler-Effect described herein, in accordance with at least one embodiment. FIG. 6 illustrates examples of wafer motion and deformation during measurement. FIG. 6 shows front and back interference intensity scan pairs in different locations on the wafer 124 (shown in FIG. 1). The upper charts in the pairs are of the front interference intensity scans. The lower charts in the pairs show back interference intensity scans.

Depending on their locale movement, some locations show significant deviations between front and back. These examples are cases of rather strong movement and deformation. Under previously existing algorithms, these would result in excessive fringe print-through artefacts.

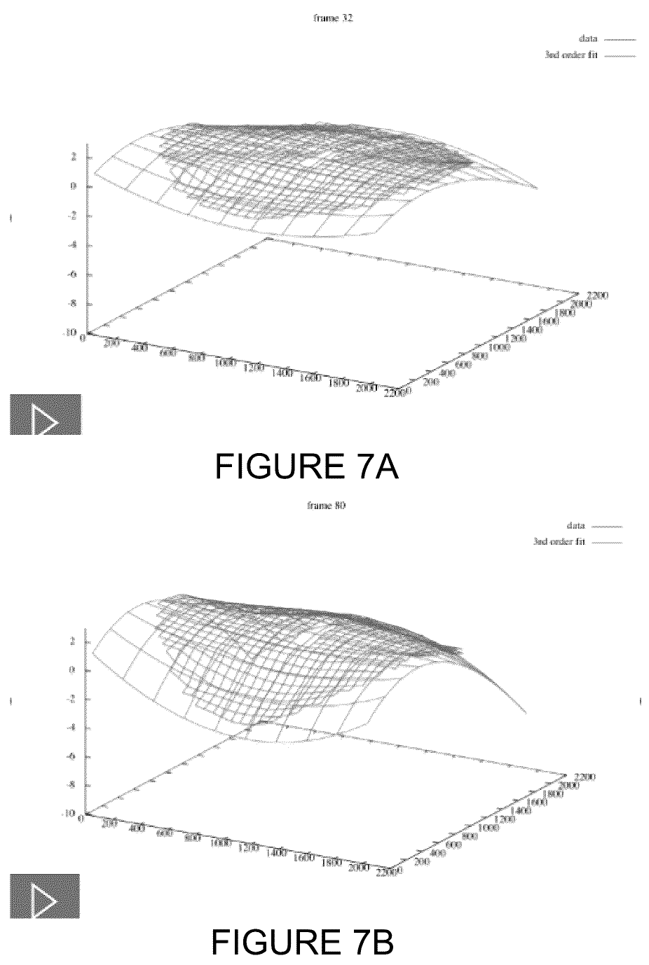

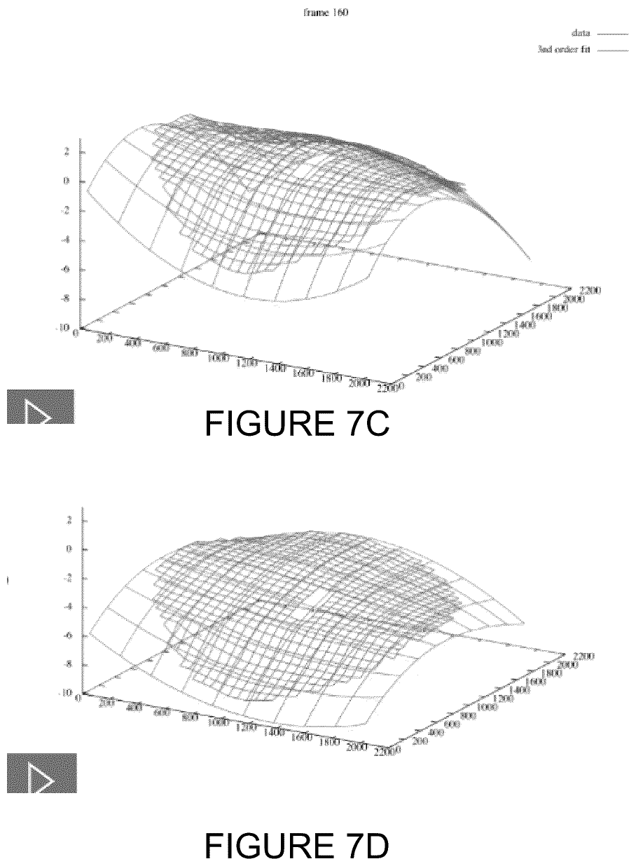

FIGS. 7A-7D show a set of graphs showing the shape change of a wafer 124 (shown in FIG. 1), relative to the first image. The graphs show the shape of the wafer 124 at different points in time during the scan of the wafer 124. The changes in the Z axis are relative to the reference planes 118 (shown in FIG. 1). The relative changes shown in FIGS. 7A-7D are in nanometers.

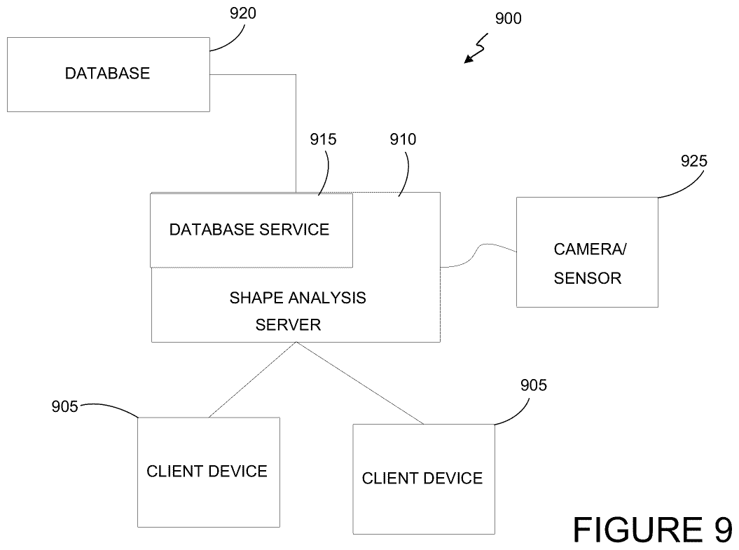

FIG. 8 illustrates a process 800 for double Fizeau-interferometer measuring thickness, shape, flatness, and nano-topography metrics of a moving and deforming wafer. In the example embodiment, process 800 is performed by the shape analysis server 910 (shown in FIG. 9).

In the exemplary embodiment, the shape analysis server 910 receives 805 a plurality of images for a continuous scan phase shift interferometry (PSI). The plurality of images are of a surface, potentially of a semiconductor wafer 124 (shown in FIG. 1). Each of the plurality of images include a first plurality of pixels of the front surface of the wafer 124. The plurality of images also include a second plurality of pixels of the back surface of the wafer 124. Each image of the plurality of images occurs during a point in a cycle of continuous phase scan interferometry. The plurality of images include a first plurality of images of a first side of the sample 124 and a second plurality of images of a second side of the sample 124. For each image of the first plurality of images there is a corresponding image of the second plurality of images that was captured at the same time as the corresponding image of the first side.

In the exemplary embodiment, the shape analysis server 910 performs 810 a first plurality of intensity scans of each pixel in the first plurality of pixels.

In the exemplary embodiment, the shape analysis server 910 performs 815 a second plurality of intensity scans of each pixel in the second plurality of pixels. In some embodiments, steps 810 and 815 are performed simultaneously. The shape analysis server 910 normalizes the first plurality of pixels and the second plurality of pixels into a range of +/−1.

In the exemplary embodiment, the shape analysis server 910 identifies 820 zero transitions for each of the first plurality of pixels. A zero transition occurs when the normalized value of a pixel changes from a positive to a negative value or from a negative value to a positive value. The zero transitions are identified with their corresponding frame numbers. For the purposes of this discussion, frame numbers are an image's position in the sequence.

In the exemplary embodiment, the shape analysis server 910 identifies 825 zero transitions for each of the second plurality of pixels. The zero transitions are identified with their corresponding frame numbers.

In the exemplary embodiment, the shape analysis server 910 compares 830 the plurality of zero transitions to determine a relative movement and deformation of the sample 124 during the PSI scan. In other embodiments, the shape analysis server 910 compares the plurality of zero transitions to determine a shape change of the sample 124 for each image of the plurality of images, relative to a first image of the plurality of images. In still further embodiments, the shape analysis server 910 compares the plurality of zero transitions to determine a shape for the sample 124 for each image of the plurality of images. The plurality of zero transitions for each of the pixels of the first side of the sample 124 are compared to the corresponding plurality of zero transitions for each of the pixels of the second side of the sample 124.

In some further embodiments, the shape analysis server 910 adjusts PSI analysis of the sample 124 based upon the comparison. In these embodiments, the shape analysis server 910 analyzes the sample 405 and determines determine whether or not to approve the sample 405 based on the analysis.

In one example embodiment, the cavity is 50 mm. The wavelength (λ) is 630 nm. In this example, one fringe period corresponds to a Δλ of 3.9 pm. In this example, the typical wavelength change over a full scan is 16 pm. The typical current tuning coefficient is 1 pm/mA. This means that changing the wavelength by current would require a change of 16 mA.

The shape analysis computer device 810 approximates IN (normalized intensity) as a function of frame index f and the common phase shift ϕ_{L}[f](ϕ_{L}[0]==0) that is generated by the laser scan. The position (x,y) dependent start phase ϕ_{x,y,c} on camera c (+1 for front and −1 for back), The time dependent wafer shape function is defined as Shape[x, y, c] (Shape[x, y, 0]==0) that approximates the wafer movement and deformation during the scan.

$$IN = Cos [ c Shape [ x , y , f ] + ω {ϕ}_{L} [ f ] + {ϕ}_{x , y , c} ] \qquad EQ . 1$$

The zero transition i will be at:

$$0 = Cos [ c Shape [ x , y , f ] + ω {ϕ}_{L} [ f ] + {ϕ}_{x , y , c} ] \qquad EQ . 2$$

$$Arc Cos [ 0 ] == \pm \frac{π}{2} \qquad EQ . 3$$

where

$$- \frac{π}{2}$$

is chosen to start counting the zero transitions at i=1. In addition, the start phase shift ϕ_{x,y,c} is substituted by zero transition phase shift:

$${ψ}_{x , y , c} = Mod [ {ϕ}_{x , y , c} , π ] + \frac{π}{2} \qquad EQ . 4$$

Accordingly, the zero transitions are numbered starting with 1, regardless of whether it is a rising or falling transition. This leads to:

$${i}_{x , y , c} π = c Shape [ x , y , {f}_{i , x , y , c} ] + ω {ϕ}_{L} [ {f}_{i , x , y , c} ] + {ψ}_{x , y , c} \qquad EQ . 5$$

with f_{i,x,y,c} the frame index (f_{i,x,y,c} ∃ 0 . . . 255) of zero transition i_{x,y,c}, where (i_{x,y,c}=1 . . . z) at location/camera (x, y, c) with zero transition phase shift ψ_{x,y,c}. IN_{x,y,c} and ΔIN_{x,y,c} are the normalized intensity and its derivative at frame 0 at pixel k. Thus

$${i}_{x , y , c} π - {ψ}_{x , y , c} - ω {ϕ}_{L} [ {f}_{i , x , y , c} ] = c Shape [ x , y , {f}_{i , x , y , c} ] \qquad EQ . 6$$

for all zero transitions, numbering zero transitions i from 1 . . . z and c being +1 for front and −1 for back surface.

The phase shift is

$${ϕ}_{kx , y , c} = Mod [ - Sign [ Δ {IN}_{x , y , c} ] * Arc Cos [ {IN}_{x , y , c} ] , 2 π ] \qquad EQ . 7$$

and the zero transition phase shift is

$$\begin{matrix}{ψ}_{x , y , c} = Mod [ {ϕ}_{x , y , c} , π ] + \frac{π}{2} \\ = Mod [ - Sign [ Δ {IN}_{x , y , c} ] * Arc Cos [ {IN}_{x , y , c} ] , π ] + \frac{π}{2}\end{matrix} \qquad EQ . 8$$

With unknown parameters aklm describing the relative shape change with incrementing frame number f as in Eq. 9 and Eq. 10 and estimated ψ_{x,y,c} (based on normalized intensity and derivative), Eq. 8 must fit all sets of [i_{x,y,c}, f_{i,x,y,c}]. According, Shape[x, y, f] is in the form of:

$$\begin{matrix}Shape [ x , y , f ] = a 00 [ f ] \\ + a 10 [ f ] x + a 01 [ f ] y \\ + a 20 [ f ] {x}^{2} + a 11 [ f ] x y + a 02 [ f ] {y}^{2} \\ + a 30 [ f ] {x}^{3} + a 21 [ f ] {x}^{2} y + a 12 [ f ] x {y}^{2} + 03 [ f ] {y}^{3}\end{matrix} \qquad EQ . 9$$

and with

$$akl [ f ] = akl 1 f + akl 2 {f}^{2} + akl 3 {f}^{3} \qquad EQ . 10$$

this leads to

$$err = c ( ( a 001 f + a 002 {f}^{2} + a 003 {f}^{3} ) + ( a 101 f + a 102 {f}^{2} + a 103 {f}^{3} ) + ( a 201 f + a 202 {f}^{2} + a 203 {f}^{3} ) + ( a 111 f + a 112 {f}^{2} + a 113 {f}^{3} ) + ( a 021 f + a 022 {f}^{2} + a 023 {f}^{3} ) + ( a 301 f + a 302 {f}^{2} + a 303 {f}^{3} ) + ( a 211 f + a 212 {f}^{2} + a 213 {f}^{3} ) + ( a 121 f + a 122 {f}^{2} + a 123 {f}^{3} ) + ( a 031 f + a 032 {f}^{2} + a 033 {f}^{3} ) ) + ω {ϕ}_{L} [ f ] - Φ i \qquad EQ . 11$$

with

$$Φ i = ( i π - ψ ) \qquad EQ . 12$$

from this, the shape analysis computer device 910 calculated the parameters of approximation by solving a matrix equation (B=M*A). The fitted polynomial describes the wafer shape change over the course of the wavelength scan and then can be used to compensate this effect in the final phase shift analysis.

While the above describes using the systems and processes described herein for analyzing silicon wafers, one having ordinary skill in the art would understand that these systems and methods may also be used for analyzing other surfaces.

FIG. 9 illustrates an example system 900 for performing the process 800 (shown in FIG. 8). In the example embodiment, the system 900 is used for double Fizeau-interferometer measuring thickness, shape, flatness, and nano-topography metrics of a moving and deforming wafer.

As described below in more detail, a shape analysis server 910 is programmed for double Fizeau-interferometer measuring thickness, shape, flatness, and nano-topography metrics of a moving and deforming wafer. The shape analysis server 910 is programmed to a) receive 805 a plurality of images for a continuous scan phase shift interferometry (PSI), wherein the plurality of images includes a first plurality of pixels of a front surface of a sample 124 and a second plurality of pixels of a back surface of the sample 124; b) simultaneously perform 810 a first plurality of intensity scans of each pixel in the first plurality of pixels and 815 a second plurality of intensity scans of each pixel in the second plurality of pixels; c) identify 820 zero transitions for each of the first plurality of pixels; d) identify 825 zero transitions for each of the second plurality of pixels; and e) compare 830 the plurality of zero transitions to determine a relative movement and deformation of the sample during the PSI scan (as shown in FIG. 8).

In the example embodiment, client devices 905 are computers that include a web browser or a software application, which enables client devices 905 to communicate with shape analysis server 910 using the Internet, a local area network (LAN), or a wide area network (WAN). In some embodiments, the client devices 905 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 905 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots or ChatGPT-based bots, or other web-based connectable equipment or mobile devices.

In the example embodiment, shape analysis computer device 910 (also known as shape analysis server 910) is a computer that include a web browser or a software application, which enables shape analysis server 910 to communicate with client devices 905 and cameras/sensors 925 using the Internet, a local area network (LAN), or a wide area network (WAN). In some embodiments, the shape analysis server 910 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The shape analysis server 910 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots or ChatGPT-based bots, or other web-based connectable equipment or mobile devices. In some embodiments, the shape analysis server 910 includes one or more of the analyzer device 102, the first computing device 104, the second computing device 106, and the third computing device 108 (all shown in FIG. 1).

A database server 915 is communicatively coupled to a database 9620 that stores data. In one embodiment, the database 920 is a database that includes a plurality of images from scans. In some embodiments, the database 920 is stored remotely from the shape analysis server 910. In some embodiments, the database 920 is decentralized. In the example embodiment, a person can access the database 920 via the client devices 905 by logging onto shape analysis server 910.

Camera/sensor 925 may be any camera and/or sensor that the shape analysis server 910 is in communication with that transmits images to the shape analysis server 910, such as the image capture device 122 (shown in FIG. 1). In the example embodiment, camera/sensors 925 that are in communication with shape analysis server 910 using the Internet, a local area network (LAN), or a wide area network (WAN). In some embodiments, the camera/sensor(s) 925 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem.

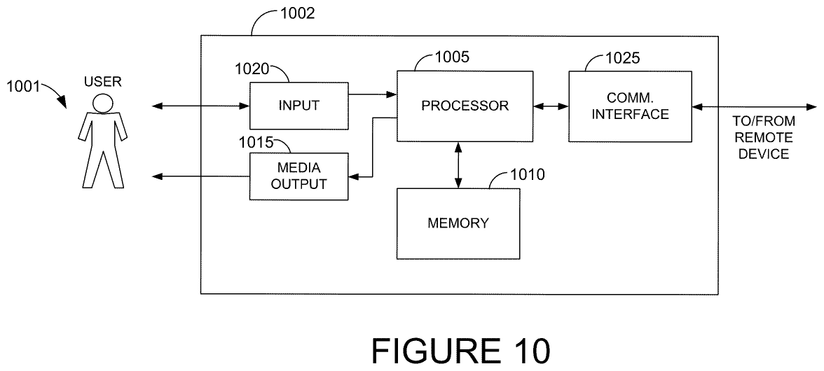

FIG. 10 depicts an example configuration 1000 of user computer device 1002. In the example embodiment, user computer device 1002 may be similar to, or the same as, client device 905 (shown in FIG. 9). User computer device 1002 may be operated by a user 1001.

User computer device 1002 may include a processor 1005 for executing instructions. In some embodiments, executable instructions may be stored in a memory area 1010. Processor 1005 may include one or more processing units (e.g., in a multi-core configuration). Memory area 1010 may be any device allowing information such as executable instructions and/or transaction data to be stored and retrieved. Memory area 1010 may include one or more computer readable media.

User computer device 1002 may also include at least one media output component 1015 for presenting information to user 1001. Media output component 1015 may be any component capable of conveying information to user 1001. In some embodiments, media output component 1015 may include an output adapter (not shown) such as a video adapter and/or an audio adapter. An output adapter may be operatively coupled to processor 1005 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 1015 may be configured to present a graphical user interface (e.g., a web browser and/or a client application) to user 1001. A graphical user interface may include, for example, an interface for viewing items of information provided by the shape analysis server 910 (shown in FIG. 9). In some embodiments, user computer device 1002 may include an input device 1020 for receiving input from user 1001. User 1001 may use input device 1020 to, without limitation, submit information either through speech or typing.

Input device 1020 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 1015 and input device 1020.

User computer device 1002 may also include a communication interface 1025, communicatively coupled to a remote device such as shape analysis server 910. Communication interface 1025 may include, for example, a wired or wireless network adapter and/or a wireless data transceiver for use with a mobile telecommunications network.

Stored in memory area 1010 are, for example, computer readable instructions for providing a user interface to user 1001 via media output component 1015 and, optionally, receiving and processing input from input device 1020. A user interface may include, among other possibilities, a web browser and/or a client application. Web browsers enable users, such as user 1001, to display and interact with media and other information typically embedded on a web page or a website from shape analysis server 910. A client application may allow user 1001 to interact with, for example, shape analysis server 910. For example, instructions may be stored by a cloud service, and the output of the execution of the instructions sent to the media output component 1015.

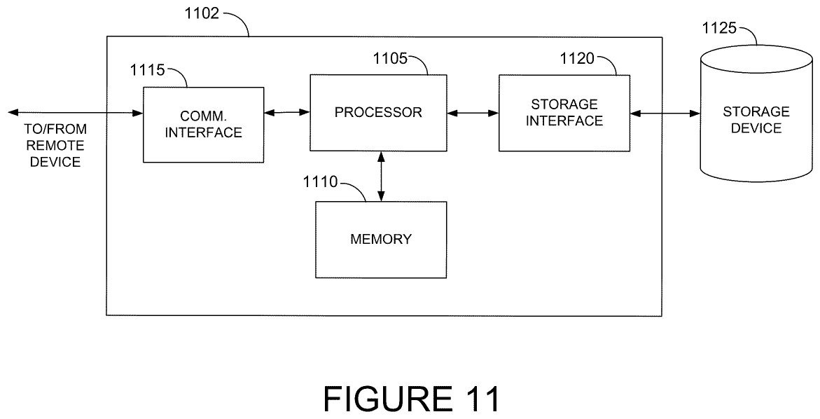

FIG. 11 depicts an example configuration 1100 of a server computer device 1102. In the example embodiment, server computer device 1102 may be similar to, or the same as, shape analysis server 910 and database server 915 (both shown in FIG. 9). Server computer device 1102 may also include a processor 1105 for executing instructions. Instructions may be stored in a memory area 1110. Processor 1105 may include one or more processing units (e.g., in a multi-core configuration).

Processor 1105 may be operatively coupled to a communication interface 1115 such that server computer device 1102 is capable of communicating with a remote device such as another server computer device 1102, shape analysis server 910, camera/sensors 925, and client devices 905 (shown in FIG. 9) (for example, using wireless communication or data transmission over one or more radio links or digital communication channels). For example, communication interface 1115 may receive input from client devices 905 via the Internet, as illustrated in FIG. 9.

Processor 1105 may also be operatively coupled to a storage device 1125. Storage device 1125 may be any computer-operated hardware suitable for storing and/or retrieving data, such as, but not limited to, data associated with one or more models. In some embodiments, storage device 1125 may be integrated in server computer device 1102. For example, server computer device 1102 may include one or more hard disk drives as storage device 1125.

In other embodiments, storage device 1125 may be external to server computer device 1102 and may be accessed by a plurality of server computer devices 1102. For example, storage device 1125 may include a storage area network (SAN), a network attached storage (NAS) system, and/or multiple storage units such as hard disks and/or solid-state disks in a redundant array of inexpensive disks (RAID) configuration.

In some embodiments, processor 1105 may be operatively coupled to storage device 1125 via a storage interface 1120. Storage interface 1120 may be any component capable of providing processor 1105 with access to storage device 1125. Storage interface 1120 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1105 with access to storage device 1125.

Processor 1105 may execute computer-executable instructions for implementing aspects of the disclosure. In some embodiments, the processor 1105 may be transformed into a special purpose microprocessor by executing computer-executable instructions or by otherwise being programmed. For example, the processor 1105 may be programmed with the instruction such as illustrated in FIG. 8.

At least one of the technical problems addressed by this system may include: (i) improve analysis of wafers; (ii) decreased loss of material due to malfunction; (iii) earlier determination of wafer quality; (iv) increased accuracy in wafer analysis; and/or (v) increased accuracy in wafer analysis.

A technical effect of the systems and processes described herein may be achieved by performing at least one of the following steps: a) receive a plurality of images for a continuous scan phase shift interferometry (PSI), wherein the plurality of images includes a first plurality of pixels of a front surface of a sample and a second plurality of pixels of a back surface of a sample; b) simultaneously perform a first plurality of intensity scans of each pixel in the first plurality of pixels and a second plurality of intensity scans of each pixel in the second plurality of pixels; c) identify zero transitions for each of the first plurality of pixels; d) identify zero transitions for each of the second plurality of pixels; e) compare the plurality of zero transitions to determine a relative movement and deformation of the sample during the PSI scan; f) wherein each image of the plurality of images occurs during a point in a cycle of continuous phase scan interferometry; g) wherein the plurality of images include a first plurality of images of a first side of the sample and a second plurality of images of a second side of the sample; h) wherein for each image of the first plurality of images there is a corresponding image of the second plurality of images that was captured at the same time as the corresponding image of the first side; i) wherein the plurality of zero transitions for each of the pixels of the first side of the sample are compared to the corresponding plurality of zero transitions for each of the pixels of the second side of the sample; j) adjust PSI analysis of the sample based upon the comparison; k) analyze the sample; l) determine whether or not to approve the sample based on the analysis; m) wherein the plurality of images are of a surface; n) wherein the surface is of a semiconductor wafer; o) normalize the first plurality of pixels and the second plurality of pixels into a range of +/−1; p) wherein the zero transitions are identified with their corresponding frame numbers; and q) compare the plurality of zero transitions to determine a shape change of the sample for each image of the plurality of images, relative to a first image of the plurality of images.

Using zero transitions of both, back and front surface guarantees best accuracy by maximizing the number of available zero transitions that go into the model fit. However, this method can also be used with just one surface.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), a reduced instruction set circuit (RISC), an application specific integrated circuit (ASIC), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer device comprising at least one processor in communication with at least one memory device, wherein the at least one processor programmed to:
receive a plurality of images for a continuous scan phase shift interferometry (PSI), wherein the plurality of images includes a first plurality of pixels of a front surface of a sample and a second plurality of pixels of a back surface of a sample;
simultaneously perform a first plurality of intensity scans of each pixel in the first plurality of pixels and a second plurality of intensity scans of each pixel in the second plurality of pixels;
identify zero transitions for each of the first plurality of pixels;
identify zero transitions for each of the second plurality of pixels; and
compare the plurality of zero transitions to determine a relative movement and deformation of the sample during the PSI scan.

2. The computer device of claim 1, wherein each image of the plurality of images occurs during a point in a cycle of continuous phase scan interferometry.

3. The computer device of claim 1, wherein the plurality of images include a first plurality of images of a first side of the sample and a second plurality of images of a second side of the sample.

4. The computer device of claim 3, wherein for each image of the first plurality of images there is a corresponding image of the second plurality of images that was captured at the same time as the corresponding image of the first side.

5. The computer device of claim 4, wherein the plurality of zero transitions for each of the pixels of the first side of the sample are compared to the corresponding plurality of zero transitions for each of the pixels of the second side of the sample.

6. The computer device of claim 1, where the at least one processor is further programmed to adjust PSI analysis of the sample based upon the comparison.

7. The computer device of claim 1, wherein the at least one processor is further programmed to:
analyze the sample; and
determine whether or not to approve the sample based on the analysis.

8. The computer device of claim 1, wherein the plurality of images are of a surface.

9. The computer device of claim 8, wherein the surface is of a semiconductor wafer.

10. The computer device of claim 1, wherein the at least one processor is further programmed to normalize the first plurality of pixels and the second plurality of pixels into a range of +/−1.

11. The computer device of claim 1, wherein the zero transitions are identified with their corresponding frame numbers.

12. The computer device of claim 1, wherein the at least one processor is further programmed to compare the plurality of zero transitions to determine a shape change of the sample for each image of the plurality of images, relative to a first image of the plurality of images.

13. A system for simultaneous phase shift interferometry of front and back of a sample, the system comprising:
at least one light source;
a first image capture device to capture images of a front surface of a sample illuminated by the at least one light source;
a second image capture device to capture images of a back surface of the sample illuminated by the at least one light source; and
a computer device comprising at least one processor in communication with at least one memory device, wherein the at least one processor programmed to:
receive a plurality of images for a continuous scan phase shift interferometry (PSI), wherein the plurality of images includes a first plurality of pixels of the front surface of a sample and a second plurality of pixels of the back surface of a sample;
simultaneously perform a first plurality of intensity scans of each pixel in the first plurality of pixels and a second plurality of intensity scans of each pixel in the second plurality of pixels;
identify zero transitions for each of the first plurality of pixels;
identify zero transitions for each of the second plurality of pixels; and
compare the plurality of zero transitions to determine a relative movement and deformation of the sample during the PSI scan.

14. The system of claim 13, wherein each image of the plurality of images occurs during a point in a cycle of continuous phase scan interferometry.

15. The system of claim 13, wherein the plurality of images include a first plurality of images of a first side of the sample and a second plurality of images of a second side of the sample.

16. The system of claim 15, wherein for each image of the first plurality of images there is a corresponding image of the second plurality of images that was captured at the same time as the corresponding image of the first side.

17. The system of claim 16, wherein the plurality of zero transitions for each of the pixels of the first side of the sample are compared to the corresponding plurality of zero transitions for each of the pixels of the second side of the sample.

18. The system of claim 13, where the at least one processor is further programmed to adjust PSI analysis of the sample based upon the comparison.

19. The system of claim 13, wherein the at least one processor is further programmed to compare the plurality of zero transitions to determine a shape change of the sample for each image of the plurality of images, relative to a first image of the plurality of images.

20. A computer-implemented method performed by a computer system including at least one processor in communication with a chatbot and at least one memory device, the method comprising:
receiving a plurality of images for a continuous scan phase shift interferometry (PSI), wherein the plurality of images includes a first plurality of pixels of a front surface of a sample and a second plurality of pixels of a back surface of a sample;
simultaneously performing a first plurality of intensity scans of each pixel in the first plurality of pixels and a second plurality of intensity scans of each pixel in the second plurality of pixels;
identifying zero transitions for each of the first plurality of pixels;
identifying zero transitions for each of the second plurality of pixels; and
comparing the plurality of zero transitions to determine a relative movement and deformation of the sample during the PSI scan.
